(19) United States
(12) Patent Application Publication
(10) Pub. No.: US 2017/0030020 A1
(43) Pub. Date: Feb. 2, 2017

(54) ELECTRICAL INSULATION PAPER, METHODS OF MANUFACTURE, AND ARTICLES MANUFACTURED THEREFROM

(71) Applicant: SABIC GLOBAL TECHNOLOGIES B.V., BERGEN OP ZOOM (NL)

(72) Inventors: THOMAS ADJEI, DALTON, MA (US); BENNY E. DAVID, GREAT BARRINGTON, MA (US); JOHN R. KRAHN, SCHENECTADY, NY (US); DENNIS LOCKYER, PITTSFIELD, MA (US); PAUL LOCKYER, PITTSFIELD, MA (US); DAVID SMITH, WASHINGTON, MO (US); ERICH O. TEUTSCH, RICHMOND, MA (US); PETER J. ZUBER, PITTSFIELD, MA (US)

(21) Appl. No.: 15/290,152

(22) Filed: Oct. 11, 2016

Related U.S. Application Data
(63) Continuation of application No. 15/040,489, filed on Feb. 10, 2016, now abandoned.
Application No. 15/040,489 is a continuation of application No. 13/723,533, filed on Dec. 21, 2012, now abandoned.

(51) Int. Cl. D21H 13/26; H01B 3/52; D21H 13/20

(52) U.S. Cl. CPC D21H 13/26; D21H 13/20; H01B 3/52

(57) ABSTRACT

Fibrous substrates containing polyetherimides and other synthetic fibers are disclosed, along with methods of preparing electrical insulation paper and articles comprising the fibrous substrates.

### CROSS REFERENCE TO RELATED APPLICATIONS

This application is a continuation of U.S. patent application Ser. No. 15/040,489 filed on Feb. 10, 2016, which is a continuation of U.S. patent application Ser. No.13/723,533 filed on Dec. 21, 2012, both of which are incorporated by reference herein in their entirety.

### BACKGROUND

This disclosure relates to electrical insulation paper.

Various types of electrical machinery contain electrical insulation paper to non-conductively isolate charged components and electrical leads from non-charged components and housing elements. Electrical insulation papers are made primarily of one of two materials: cellulose or aramid fibers. Both of these materials have noticeable moisture up-take which has a negative effect on the electrical properties of the materials as well as the system-level performance of the insulation system. Consequently, extensive drying operations and manufacturing care need to be observed so that these materials stay sufficiently dry.

In addition, the cellulose papers have a limited thermal capability such that natural cellulose-based materials start showing significant long-term degradation during exposure to temperatures exceeding about 120° C. Moreover, the cellulose degradation mechanism is not only catalyzed by water, but also produces water as a by-product, which may result in a cascading cycle of auto-catalytic degradation.

On the other hand, aramid fiber papers such as Nomex are relatively costly and represent “thermal-overkill” for many of the applications in which they are used. For example, while most motors have Class-F (155° C.) or Class-H (180° C.) insulation systems, Nomex is Class-220° C. insulation. In such applications, the full thermal capability of the Nomex electrical insulation paper is not a design requirement and the Nomex can thus be viewed as an unnecessary excess cost.

There accordingly remains a need in the art for electrical grade insulation paper that has significantly less moisture up-take than cellulose and Nomex, and that are inexpensive to manufacture. It would be a further advantage if such fibers could operate at high temperature. There remains a further need for efficient methods for producing such electrical papers.

### BRIEF SUMMARY OF THE INVENTION

In one embodiment, a fibrous substrate comprising a consolidated product of a fiber composition is provided comprising, based on the total weight of fibers in the fiber composition:

from about 10 to about 65 wt. % of polyimide fibers;

from about 10 to about 30 wt. % of fibers selected from aromatic polyamide fibrids or polycarbonate fibers;

from about 25 to about 70 wt. % aromatic polyamide fibers;

wherein the consolidated product has:

(1) resistivity of at least 1000 MOhm-cm;

(2) electrical breakdown strength of at least 600 Volt/mil;

(3) thermal capability exceeding the standards for NEMA Class F (155° C.) and NEMA Class H (180° C.) insulation, and has 5 or less wt. % gain due to water saturation at 100% Relative Humidity;

(4) tear strength, measured as Elmendorf tear strength of at least 85 mN; and

(5) a thickness of from more than 0 to less than 8 mils.

In another embodiment, an electrical paper is disclosed comprising a fibrous substrate having a first side and a second side opposite the first side, and comprising a consolidated product of a fiber composition comprising:

about 20 to 65 wt. % of polyimide fibers;

about 30 to 70 wt. % of aromatic polyamide fibers;

about 10 to 30 wt. % aromatic polyamide fibrids;

each based on the total weight of these fibers in the fiber composition; and having

a first layer comprising about 75 to 95 wt. % polyimide fibers and about 5 to 25 wt. % aromatic polyamide fibrids disposed on the first side of the fibrous substrate; and

a second layer comprising about 75 to 95 wt. % polyimide fibers and about 5 to 25 wt. % aromatic polyamide fibrids disposed on the second side of the fibrous substrate,

wherein the electrical paper has:
(1) resistivity of at least 1000 MOhm-cm;
(2) electrical breakdown strength of at least 600 V/mil;
(3) thermal capability exceeding the standards for NEMA Class F (155° C.) and NEMA Class H (180° C.) insulation, and has 5 or less wt. % gain due to water saturation at 100% Relative Humidity,
(4) tear strength, measured as Elmendorf tear strength of at least 85 mN, and
(5) a thickness of from more than 0 to less than 80 mil.

In a further embodiment, an electrical paper is disclosed comprising

a fibrous substrate having a first side and a second side opposite the first side, and comprising a consolidated product of a fiber composition comprising:

about 75 to 95 wt. % polyimide fibers and about 5 to 25 wt. % aromatic polyamide fibrids

each based on the total weight of these fibers in the fiber composition; a first layer comprising:

about 35 to 45 wt. % of polyimide fibers;

about 35 to 45 wt. % of aromatic polyamide fibers;

about 10 to 30 wt. % aromatic polyamide fibrids;

disposed on the first side of the fibrous substrate; and

a second layer comprising:

about 35 to 45 wt. % of polyimide fibers;

about 35 to 45 wt. % of aromatic polyamide fibers;

about 10 to 30 wt. % aromatic polyamide fibrids;

disposed on the second side of the fibrous substrate,

wherein the electrical paper has:
(1) resistivity of at least 1000 MOhm-cm;
(2) electrical breakdown strength of at least 600 V/mil;
(3) thermal capability exceeding the standards for NEMA Class F (155° C.) and NEMA Class H (180° C.) insulation, and has 5 or less wt. % gain due to water saturation at 100% Relative Humidity,
(4) tear strength, measured as Elmendorf tear strength of at least 85 mN, and
(5) a thickness of from more than 0 to less than 80.

In another embodiment, a process of preparing a fibrous substrate is disclosed, comprising

forming a layer from a slurry comprising

a suspension solvent; and fiber composition comprising a combination of

about 20 to 65 wt. % of polyimide fibers;

about 30 to 70 wt. % of aromatic polyamide fibers;

about 10 to 30 wt. % aromatic polyamide fibrids;

each based on the total weight of the fibers in the fiber composition;

dewatering the layer; and

consolidating the layer to form the fibrous substrate;

wherein a layer of about 75 to 95 wt. % polyimide fiber and 5 to 25 wt. % aromatic polyamide fibrid is applied to each surface of the fibrous substrate either before or after said consolidating step, and the substrate and polyimide layers are together subjected to a consolidating step.

In another embodiment, articles comprising the above fibrous substrates are provided.

### DETAILED DESCRIPTION OF THE INVENTION

The present inventors have discovered that moisture-resistant electrical grade fibrous substrates can be manufactured using a combination of polyetherimide fibers and aromatic polyamide fibrids. The paper is produced by mixing several different chopped, thermoplastic polymer fibers chosen to have melt temperatures differing sufficiently to permit consolidation, during which the primary polymer is pressed into a continuous film, while the reinforcing fiber polymer remains as un-melted fibers. In an embodiment, the consolidated substrates contain melted polyetherimide fibers which form a continuous or semi-continuous matrix, making a film-like structure within the paper.

The fibrous substrates can be thermally stable at high temperatures, have high mechanical strength and modulus, low creep, and/or good chemical stability.

The term “fibers” as used herein includes a wide variety of structures having a single filament with an aspect ratio (length : diameter) of greater than 2, specifically greater than 5, greater than 10, or greater than 100. The term fibers also includes fibrets (very short (length less than 1 mm), fine (diameter less than 50 micrometers (μm)) fibrillated fibers that are highly branched and irregular resulting in high surface area), and fibrils, tiny threadlike elements of a fiber. The diameter of a fiber is indicated by its fiber number, which is generally reported as either dtex or dpf. The numerical value reported as “dtex” indicates the mass in grams per 10,000 meters of the fiber. The numerical value “dpf” represents the denier per fiber. The denier system of measurement is used on two and single filament fibers, and dpf.=Total Denier/Quantity of Uniform Filaments. Some common denier-related calculations are as follows:

1 denier=1 gram per 9 000 meters=0.05 grams per 450 meters=0.111 milligrams per meter.

In practice, measuring 9,000 meters is cumbersome and usually a sample of 900 meters is weighed and the result multiplied by 10 to obtain the denier weight.

The term “fibrids”, as used herein, means very small, non-granular, fibrous or film-like particles with at least one of their three dimensions being of minor magnitude relative to the largest dimension, such that they are essentially two-dimensional particles, typically having a length from greater than 0 to less than 0.3 mm, and a width of from greater than 0 to less than 0.3 mm and a depth of from greater than 0 to less than 0.1 mm. A preferred size for the fibrids is 100 μm×100 μm×0.1 μm.

Fibrids are typically made by streaming a polymer solution into a coagulating bath of liquid that is immiscible with the solvent of the solution. The stream of polymer solution is subjected to strenuous shearing forces and turbulence as the polymer is coagulated. The fibrid material of this invention can be selected from meta or para-aramid or blends thereof. More preferably, the fibrid is a para-aramid. Such aramid fibrids, before being dried, can be used wet and can be deposited as a binder physically entwined about the flock component of a paper.

Various numerical ranges are disclosed in this patent application. Because these ranges are continuous, they include every value between the minimum and maximum values. Unless expressly indicated otherwise, the various numerical ranges specified in this application are approximations. The endpoints of all ranges directed to the same component or property are inclusive of the endpoint and independently combinable.

The terms “a” and “an” do not denote a limitation of quantity, but rather denote the presence of at least one of the referenced items. As used herein, “combination thereof” is inclusive of one or more of the recited elements, optionally together with a like element not recited. Reference throughout the specification to “an embodiment,” “another embodiment, “some embodiments,” and so forth, means that a particular element (e.g., feature, structure, property, and/or characteristic) described in connection with the embodiment is included in at least an embodiment described herein, and may or may not be present in other embodiments. In addition, it is to be understood that the described element(s) can be combined in any suitable manner in the various embodiments.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. The term “alkyl” includes both C1-30 branched and straight chain, unsaturated aliphatic hydrocarbon groups having the specified number of carbon atoms. Examples of alkyl include, but are not limited to, methyl, ethyl, n-propyl, i-propyl, n-butyl, s-butyl, t-butyl, n-pentyl, s-pentyl, n- and s-hexyl, n-and s-heptyl, and, n- and s-octyl. The term “aryl” means an aromatic moiety containing the specified number of carbon atoms and optionally 1 to 3 heteroatoms (e.g., O, S, P, N, or Si), such as to phenyl, tropone, indanyl, or naphthyl.

All molecular weights in this application refer to weight average molecular weights unless indicated otherwise. All such mentioned molecular weights are expressed in Daltons.

All ASTM tests are based on the 2003 edition of the Annual Book of ASTM Standards unless otherwise indicated.

Polyetherimides comprise more than 1, for example 10 to 1000 or 10 to 500 structural units, of formula (1)

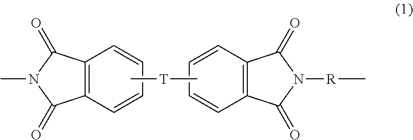

wherein each R is the same or different, and is a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of formula (2)

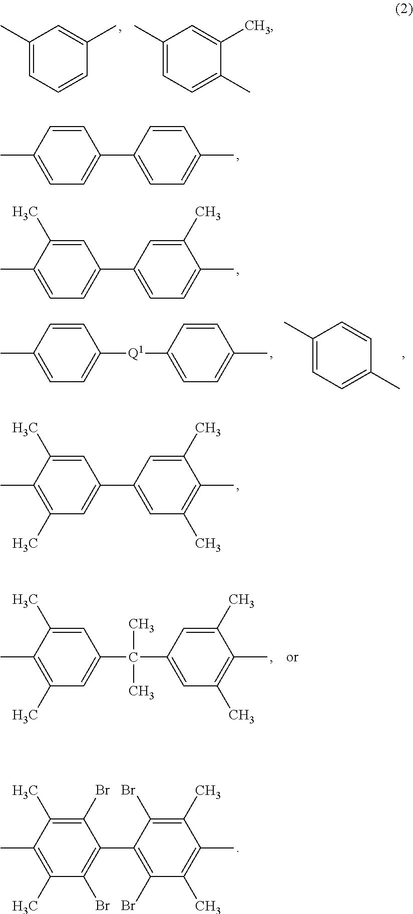

wherein Q¹ is —O—, —S—, —C(O)—, —SO₂—, —SO—, or —C_{y}H_{2y}— wherein y is an integer from 1 to 5 or a halogenated derivative thereof (which includes perfluoroalkylene groups). In an embodiment R is m-phenylene or p-phenylene.

Further in formula (1), T is —O— or a group of the formula —O—Z—O— wherein the divalent bonds of the —O— or the —O—Z—O— group are in the 3,3′,3,4′,4,3′, or the 4,4′ positions. The group Z in formula (1) is the same or different, and is also a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3):

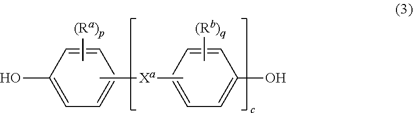

wherein R^{a} and R^{b} can be the same or different and are a halogen atom or a monovalent C₁₋₆ alkyl group, for example ; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formulas (3a)

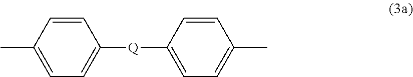

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is derived from bisphenol A wherein Q in formula (3a) is 2,2-isopropylidene.

In an embodiment in formula (1), R is m-phenylene or p-phenylene and T is —O—Z—O wherein Z is a divalent group of formula (3a). Alternatively, R is m-phenylene or p-phenylene and T is —o—Z—O wherein Z is a divalent group of formula (3a) and Q is 2,2-isopropylidene.

In some embodiments, the polyetherimide can be a copolymer, for example, a polyetherimide sulfone copolymer comprising structural units of formula (1) wherein at least 50 mole % of the R groups are of formula (2) wherein Q¹ is —SO2- and the remaining R groups are independently p-phenylene or m-phenylene or a combination comprising at least one of the foregoing; and Z is 2,2-(4-phenylene)isopropylidene. Alternatively, the polyetherimide optionally comprises additional structural imide units, for example imide units of formula (4)

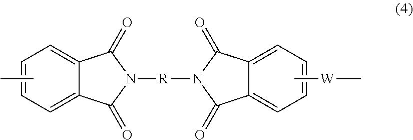

wherein R is as described in formula (1) and W is a linker of the formulas

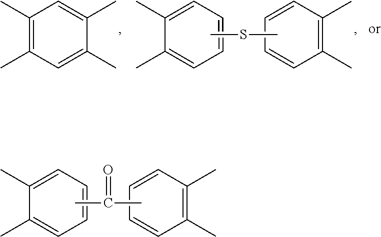

These additional structural imide units can be present in amounts from 0 to 10 mole % of the total number of units, specifically 0 to 5 mole %, more specifically 0 to 2 mole %. In an embodiment no additional imide units are present in the polyetherimide.

The polyetherimide can be prepared by any of the methods well known to those skilled in the art, including the reaction of an aromatic bis(ether anhydride) of formula (5)

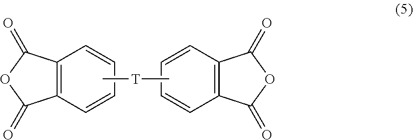

with an organic diamine of formula (6)

H₂N—R—NH₂ (6)

wherein T and R are defined as described above. Copolymers of the polyetherimides can be manufactured using a combination of an aromatic bis(ether anhydride) of formula (5) and a different bis(anhydride), for example a bis(anhydride) wherein T does not contain an ether functionality, for example T is a sulfone.

Illustrative examples of bis(anhydride)s include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations thereof.

Examples of organic diamines include ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethy1-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone, and bis(4-aminophenyl) ether. Combinations of these compounds can also be used. In some embodiments the organic diamine is m-phenylenediamine, p-phenylenediamine, sulfonyl dianiline, or a combination comprising one or more of the foregoing.

Included among the many methods of making polyetherimides are those disclosed in U.S. Pat. Nos. 3,847,867, 3,852,242, 3,803,085, 3905,942, 3,983,093, 4,443,591 and 7,041,773. These patents mentioned for the purpose of teaching, by way of illustration, general and specific methods for preparing polyimides. Some polyetherimide (PEI) materials are described in ASTM D5205-96 Standard Classification System for Polyetherimide Materials.

Polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide polymer has a weight average molecular weight (Mw) of 1,000 to 150,000 grams/mole (Dalton), as measured by gel permeation chromatography, using polystyrene standards. In some embodiments the polyetherimide has Mw of 10,000 to 80,000 Daltons. Such polyetherimide polymers typically have an intrinsic viscosity greater than 0.2 deciliters per gram (dl/g), or, more specifically, 0.35 to 0.7 dl/g as measured in m-cresol at 25° C.

In an embodiment, the polyetherimide comprises less than 50 ppm amine end groups. In other instances the polymer will also have less than 1 ppm of free, unpolymerized bisphenol A (BPA).

The polyetherimides can have low levels of residual volatile species, such as residual solvent and/or water. In some embodiments, the polyetherimides have a residual volatile species concentration of less than 1000 parts by weight per million parts by weight (ppm), or, more specifically, less than 500 ppm, or, more specifically, less than 300 ppm, or, even more specifically, less than 100 ppm. In some embodiments, the composition has a residual volatile species concentration of less than 1000 parts by weight per million parts by weight (ppm), or, more specifically, less than 500 ppm, or, more specifically, less than 300 ppm, or, even more specifically, less than 100 ppm.

Examples of residual volatile species are halogenated aromatic compounds such as chlorobenzene, dichlorobenzene, trichlorobenzene, aprotic polar solvents such as dimethyl formamide (DMF), N-methyl pyrrolidinone (NMP), dimethyl sulfoxide (DMSO), diaryl sulfones, sulfolane, pyridine, phenol, veratrole, anisole, cresols, xylenols, dichloro ethanes, tetra chloro ethanes, pyridine and mixtures thereof.

Low levels of residual volatile species in the final polymer product can be achieved by known methods, for example, by devolatilization or distillation. In some embodiments the bulk of any solvent can be removed and any residual volatile species can be removed from the polymer product by devolatilization or distillation, optionally at reduced pressure. In other embodiments the polymerization reaction is taken to some desired level of completion in solvent and then the polymerization is essentially completed and most remaining water is removed during at least one devolatilization step following the initial reaction in solution. Apparatuses to devolatilize the polymer mixture and reduce solvent and other volatile species to the low levels needed for good melt processability are generally capable of high temperature heating under vacuum with the ability to rapidly generate high surface area to facilitate removal of the volatile species. The mixing portions of such apparatuses are generally capable of supplying sufficient power to pump, agitate, and stir the high temperature, polyetherimide melt which can be very viscous. Suitable devolatilization apparatuses include, but are not limited to, wiped films evaporators, for example those made by the LUWA Company and devolatilizing extruders, especially twin screw extruders with multiple venting sections, for example those made by the Werner Pfleiderer Company or Welding Engineers.

In some embodiments the polyetherimide has a glass transition temperature of 200 to 280° C.

It is often useful to melt filter the polyetherimide using known melt filtering techniques to remove foreign material, carbonized particles, cross-linked resin, or similar impurities. Melt filtering can occur during initial resin isolation or in a subsequent step. The polyetherimide can be melt filtered in the extrusion operation. Melt filtering can be performed using a filter with pore size sufficient to remove particles with a dimension of greater than or equal to 100 micrometers or with a pore size sufficient to remove particles with a dimension of greater than or equal to 40 micrometers.

The polyetherimide composition can optionally comprise additives such as UV absorbers, stabilizers such as light stabilizers and others, lubricants, plasticizers, pigments, dyes, colorants, anti-static agents, metal deactivators, and combinations comprising one or more of the foregoing additives. In some embodiments, the additive can include a combination of a mold release agent and a stabilizer selected from phosphite stabilizers, phosphonite stabilizers, hindered phenol stabilizers, and combinations thereof In an embodiment, a phosphorus-containing stabilizer is used.

Antioxidants can be compounds such as phosphites, phosphonites, hindered phenols, or combinations thereof Phosphorus-containing stabilizers including triaryl phosphites and aryl phosphonates are of note as useful additives. Difunctional phosphorus containing compounds can also be employed. In some embodiments, to prevent loss of the stabilizer during melt mixing or subsequent melt forming processes such as injection molding, the phosphorus containing stabilizers with a molecular weight greater than or equal to 300 Dalton, but less than or equal to 5,000 Dalton, are useful. The additive can comprise hindered phenols with molecular weight over 500 Dalton. Phosphorus-containing stabilizers can be present in the composition at 0.01 to 3.0% or to 1.0% by weight of the total composition.

In an embodiment, the polyetherimide fibers are selected from polyetherimide fibers, polyetherimidesulfone fibers, polyetheramideimide fibers, and combinations thereof

The fibrous substrates further comprise fibers composed of materials other than the polyetherimide. The other fibers can be high strength, heat resistant organic fibers such as aromatic polyamides (including homopolymers and copolymers) and aromatic polyester fibers (including homopolymer and copolymers). Such fibers can have a strength of about 10 g/D to about 50 g/D, specifically 15 g/D to 50 g/D, and a pyrolysis temperature of greater than 300° C., specifically greater than about 350° C. As used herein, an “aromatic” polymer contains at least 85 mole % of the polymer linkages (e.g., —CO—NH—) attached directly to two aromatic rings.

Aromatic polyamide fibers are also known as aramid fibers, which can be broadly categorized as para-aramid fibers or meta-aramid fibers. Illustrative examples of para-aramid fibers include poly(p-phenylene terephthalamide) fibers (produced, e.g., by E. I. Du Pont de Nemours and Company and Du Pont-Toray Co., Ltd. under the trademark KEVLAR®), p-phenylene terephthalamide/p-phenylene 3,4′-diphenylene ether terephthalamide copolymer fibers (produced by Teijin Ltd. under the trade name TECHNORA), (produced by Teijin Ltd. under the trade name designation TWARON), or combinations thereof Illustrative examples of meta-aramid fibers include poly(m-phenylene terephthalamide) fibers (produced, e.g., by E. I. Du Pont de Nemours and Company under the trademark NOMEX®). Such aramid fibers can be produced by methods known to one skilled in the art. In a specific embodiment, the aramid fibers are para-type homopolymers, for example poly(p-phenylene terephthalamide) fibers.

Aramid fibrids are a preferred ingredient in the fibrous substrate. Fibrids are typically made by streaming a polymer solution into a coagulating bath of liquid that is immiscible with the solvent of the solution. The stream of polymer solution is subjected to strenuous shearing forces and turbulence as the polymer is coagulated. The fibrid material of this invention can be selected from meta or para-aramid or blends thereof More preferably, the fibrid is a para-aramid. Such aramid fibrids, before being dried, can be used wet and can be deposited as a binder physically entwined about the floc component of a paper.

The fibrous substrate may also comprise polycarbonate fibers. Polycarbonates are polymers having repeating structural carbonate units (1)

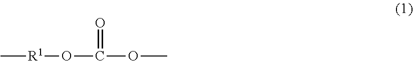

in which at least 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from an aromatic dihydroxy compound of the formula HO—R¹—OH, in particular (2)

HO-A¹-Y¹-A²)OH (2)

wherein each of A¹ and A² is a monocyclic divalent aromatic group and Y¹ is a single bond or a bridging group having one or more atoms that separate A¹ from A². In an exemplary embodiment, one atom separates A¹ from A². Also included are compounds (3)

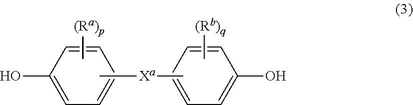

wherein R^{a} and R^{b} are each independently a halogen atom or a monovalent hydrocarbon group and may be the same or different; p and q are each independently integers of 0 to 4; and X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is a single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as a halogen, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In particular, X^{a} is a C₁₋₁₈ alkylene group, a C₃₋₁₈ cycloalkylene group, or a fused C₆₋₁₈ cycloalkylene group, or a group of the formula B²—wherein B¹ and B² are the same or different C₁₋₆ alkylene group and W is a C₃₋₁₂ cycloalkylidene group or a C₆₋₁₆ arylene group.

Exemplary C₁₋₁₈ organic bridging groups include methylene, cyclohexylmethylene, ethylidene, neopentylidene, and isopropylidene, as well as 2-[2.2.1]-bicycloheptylidene and cycloalkylidenes such as cyclohexylidene, cyclopentylidene, cyclododecylidene, and adamantylidene. A specific example of bisphenol (3) wherein X^{a} is a substituted cycloalkylidene is the cyclohexylidene-bridged, alkyl-substituted bisphenol (4)

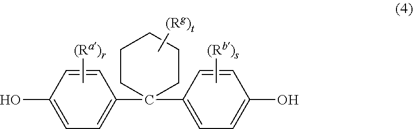

wherein R^{a′} and R^{b′} are each independently C₁₋₁₂ alkyl, R^{g} is C₁₋₁₂ alkyl or halogen, r and s are each independently 1 to 4, and t is 0 to 10. In a specific embodiment, at least one of each of R^{a′} and R^{b′} is disposed meta to the cyclohexylidene bridging group. The substituents R^{a′}, R^{b′}, and R^{g} can, when comprising an appropriate number of carbon atoms, be a straight chain, cyclic, bicyclic, branched, saturated, or unsaturated. In an embodiment, R^{a′} and R^{b′} are each independently C₁₋₄ alkyl, R^{g} is C₁₋₄ alkyl, r and s are each 1, and t is 0 to 5. In another specific embodiment, R^{a′}, R^{b′} and R^{g} are each methyl, r and s are each 1, and t is 0 or 3. In another exemplary embodiment, the cyclohexylidene-bridged bisphenol is the reaction product of two moles of a cresol with one mole of a hydrogenated isophorone (e.g., 1,1,3-trimethyl-3-cyclohexane-5-one).

X^{a} in bisphenol (3) can also be a substituted C₃₋₁₈ cycloalkylidene (5)

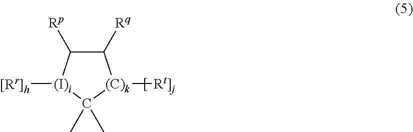

wherein R^{r}, R^{p}, R^{q}, and R^{t} are independently hydrogen, halogen, oxygen, or C₁₋₁₂ organic groups; I is a direct bond, a carbon, or a divalent oxygen, sulfur, or —N(Z)— where Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (5) will have an unsaturated carbon-carbon linkage where the ring is fused. When k is one and i is 0, the ring as shown in formula (5) contains 4 carbon atoms, when k is 2, the ring as shown in formula (5) contains 5 carbon atoms, and when k is 3, the ring contains 6 carbon atoms. In an embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

In another specific embodiment of the bisphenol compound (3), the C₁₋₁₈ organic bridging group includes groups —C(R^{c})(R^{d})— or —C(═R^{e})—, wherein R^{e} and R^{d} are each independently a hydrogen atom or a monovalent linear or cyclic hydrocarbon group and R^{e} is a divalent hydrocarbon group, p and q is each 0 or 1, and R^{a} and R^{b} are each a C₁₋₃ alkyl group, specifically methyl, disposed meta to the hydroxy group on each arylene group.

Other useful aromatic dihydroxy compounds of the formula HO—R¹—OH include compounds (7)

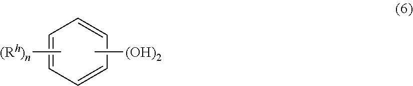

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyOmethane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha'-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-pheny1-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

“Polycarbonate” as used herein includes homopolycarbonates (wherein each R¹ in the polymer is the same), copolymers comprising different R¹ moieties in the carbonate units (referred to herein as “copolycarbonates”), copolymers comprising carbonate units and other types of polymer units, such as ester units, and combinations comprising at least one homopolycarbonate and/or copolycarbonate. As used herein, a “combination” is inclusive of blends, mixtures, alloys, reaction products, and the like.

A specific polycarbonate copolymer is a poly(carbonate-ester). Such copolymers further contain, in addition to recurring carbonate units (1), repeating units (7)

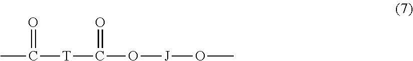

wherein J is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T divalent group derived from a dicarboxylic acid, and can be, for example, a C₂₋₁₀ alkylene group, a C₆₋₂₀ alicyclic group, a C₆₋₂₀ alkyl aromatic group, or a C₆₋₂₀ aromatic group. Poly(carbonate-ester)s containing a combination of different T and/or J groups can be used. The poly(carbonate-ester)s can be branched or linear.

In an embodiment, J is a C₂₋₃₀ alkylene group having a straight chain, branched chain, or cyclic (including polycyclic) structure. In another embodiment, J is derived from an aromatic dihydroxy compound (3). In another embodiment, J is derived from an aromatic dihydroxy compound (4). In another embodiment, J is derived from an aromatic dihydroxy compound (6).

Exemplary aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, or a combination comprising at least one of the foregoing acids. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, cyclohexane dicarboxylic acid, or a combination comprising at least one of the foregoing acids. A specific dicarboxylic acid comprises a combination of isophthalic acid and terephthalic acid wherein the weight ratio of isophthalic acid to terephthalic acid is about 91:9 to about 2:98. In another specific embodiment, J is a C₂₋₆ alkylene group and T is p-phenylene, m-phenylene, naphthalene, a divalent cycloaliphatic group, or a combination thereof

The molar ratio of carbonate units to ester units in the copolymers can vary broadly, for example 1:99 to 99:1, specifically 10:90 to 90:10, more specifically 25:75 to 75:25, depending on the desired properties of the final composition.

A specific embodiment of a poly(carbonate-ester) (8) comprises recurring aromatic carbonate and aromatic ester units

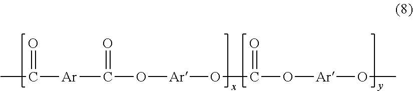

wherein Ar is divalent aromatic residue of a dicarboxylic acid or combination of dicarboxylic acids, and Ar′ is a divalent aromatic residue of a bisphenol (3) or a dihydric compound (6). Ar is thus an aryl group, and is preferably the residue of isophthalic acid (9a), terephthalic acid (9b),

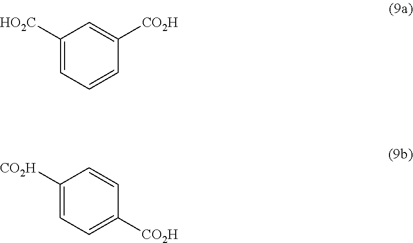 [SMILES: O=C(O)c1cccc(C(=O)O)c1 ; O=C(O)c1ccc(C(=O)O)cc1]

or a combination thereof Ar′ may be polycyclic, e.g., a residue of biphenol or bisphenol A, or monocyclic, e.g., the residue of hydroquinone or resorcinol.

Further in the poly(carbonate-ester) (8), x and y represent the respective parts by weight of the aromatic ester units and the aromatic carbonate units based on 100 parts total weight of the copolymer. Specifically, x, the aromatic ester content, is 20 to 100, specifically 30 to 95, still more specifically 50 to 95 parts by weight, and y, the carbonate content, is from more than zero to 80, from 5 to 70, still more specifically from 5 to 50 parts by weight. In general, any aromatic dicarboxylic acid conventionally used in the preparation of polyesters may be utilized in the preparation of poly(carbonate-ester)s (8) but terephthalic acid alone can be used, or mixtures thereof with isophthalic acid wherein the weight ratio of terephthalic acid to isophthalic acid is in the range of from 5:95 to 95:5. In this embodiment the poly(carbonate-ester) (8) can be derived from reaction of bisphenol-A and phosgene with iso- and terephthaloyl chloride, and can have an intrinsic viscosity of 0.5 to 0.65 deciliters per gram (measured in methylene chloride at a temperature of 25° C.). Copolymers of formula (8) comprising 35 to 45 wt. % of carbonate units and 55 to 65 wt. % of ester units, wherein the ester units have a molar ratio of isophthalate to terephthalate of 45:55 to 55:45 are often referred to as poly(carbonate-ester)s (PCE) and copolymers comprising 15 to 25 wt. % of carbonate units and 75 to 85 wt. % of ester units having a molar ratio of isophthalate to terephthalate from 98:2 to 88:12 are often referred to as poly(phthalate-carbonate)s (PPC).

In another specific embodiment, the poly(carbonate-ester) comprises carbonate units (1) derived from a bisphenol compound (3), and ester units derived from an aromatic dicarboxylic acid and dihydroxy compound (6). Specifically, the ester units are arylate ester units (9)

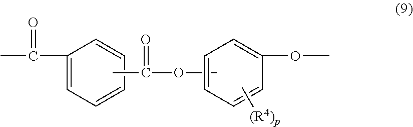

wherein each R⁴ is independently a halogen or a C₁₋₄ alkyl, and p is 0 to 3. The arylate ester units can be derived from the reaction of a mixture of terephthalic acid and isophthalic acid or chemical equivalents thereof with compounds such as 5-methyl resorcinol, 5-ethyl resorcinol, 5-propyl resorcinol, 5-butyl resorcinol, 5-t-butyl resorcinol, 2,4,5-trifluoro resorcinol, 2,4,6-trifluoro resorcinol, 4,5,6-trifluoro resorcinol, 2,4,5-tribromo resorcinol, 2,4,6-tribromo resorcinol, 4,5,6-tribromo resorcinol, catechol, hydroquinone, 2-methyl hydroquinone, 2-ethyl hydroquinone, 2-propyl hydroquinone, 2-butyl hydroquinone, 2-t-butyl hydroquinone, 2,3,5-trimethyl hydroquinone, 2,3,5-tri-t-butyl hydroquinone, 2,3,5-trifluoro hydroquinone, 2,3,5-tribromo hydroquinone, or a combination comprising at least one of the foregoing compounds. The ester units can be poly(isophthalate-terephthalate-resorcinol ester) units, also known as “ITR” esters.

The poly(carbonate-ester)s comprising ester units (9) can comprise, based on the total weight of the copolymer, from 1 to less than 100 wt. %, 10 to less than 100 wt. %, 20 to less than 100 wt. %, or 40 to less than 100 wt. % of carbonate units (1) derived from a bisphenol compound (3), and from greater than 0 to 99 wt. %, greater than 0 to 90 wt. %, greater than 0 to 80 wt. %, or greater than 0 to 60 wt. % of ester units derived from an aromatic dicarboxylic acid and dihydroxy compound (6). A specific poly(carbonate-ester) comprising arylate ester units (9) is a poly(bisphenol-A carbonate)-co-poly(isophthalate-terephthalate-resorcinol ester).

In another specific embodiment, the poly(carbonate-ester) contains carbonate units (1) derived from a combination of a bisphenol (3) and a dihydroxy compound (6), and arylate ester units (9). The molar ratio of carbonate units derived from dihydroxy compound (3) to carbonate units derived from dihydroxy compound (6) can be 1:99 to 99:1. A specific poly(carbonate-ester) of this type is a poly(bisphenol-A carbonate)-co-(resorcinol carbonate)-co(isophthalate-terephthalate-resorcinol ester).

Polycarbonates can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as triethylamine and/or a phase transfer catalyst, under controlled pH conditions, e.g., about 8 to about 12. The most commonly used water immiscible solvents include methylene chloride, 1,2-dichloroethane, chlorobenzene, toluene, and the like.

Exemplary carbonate precursors include a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary embodiment, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt. % based on the weight of bisphenol in the phosgenation mixture. In another embodiment an effective amount of phase transfer catalyst can be about 0.5 to about 2 wt. % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of about 0.05 to about 2.0 wt. %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates. Mono-phenolic chain stoppers are exemplified by monocyclic phenols such as phenol and C₁-C₂₂ alkyl-substituted phenols such as p-cumyl-phenol, resorcinol monobenzoate, and p-and tertiary-butyl phenol; and monoethers of diphenols, such as p-methoxyphenol. Alkyl-substituted phenols with branched chain alkyl substituents having 8 to 9 carbon atoms can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Alternatively, melt processes can be used to make the polycarbonates. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diary1 carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl) carbonate, bis(2-acetylphenyl) carboxylate, bis(4-acetylphenyl) carboxylate, or a combination comprising at least one of the foregoing esters. In addition, useful transesterification catalysts can include phase transfer catalysts of formula (R³)₄Q⁺X, wherein each R³, Q, and X are as defined above. Exemplary transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

The polyester-polycarbonates in particular can also be prepared by interfacial polymerization as described above with respect to polycarbonates generally. Rather than utilizing the dicarboxylic acid or diol per se, the reactive derivatives of the acid or diol, such as the corresponding acid halides, in particular the acid dichlorides and the acid dibromides can be used. Thus, for example instead of using isophthalic acid, terephthalic acid, or a combination comprising at least one of the foregoing acids, isophthaloyl dichloride, terephthaloyl dichloride, or a combination comprising at least one of the foregoing dichlorides can be used.

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight of 10,000 to 200,000 Daltons, specifically 20,000 to 100,000 Daltons, as measured by gel permeation chromatography (GPC), using a cross-linked styrene-divinylbenzene column and calibrated to polycarbonate references. GPC samples are prepared at a concentration of 1 mg per ml, and are eluted at a flow rate of 1.5 ml per minute. Combinations of polycarbonates of different flow properties can be used to achieve the overall desired flow property. In an embodiment, polycarbonates are based on bisphenol A, in which each of A³ and A⁴ is p-phenylene and Y² is isopropylidene. The weight average molecular weight of the polycarbonate can be 5,000 to 100,000 Daltons, or, more specifically 10,000 to 65,000 Daltons, or, even more specifically, 15,000 to 35,000 Daltons as determined by GPC as described above.

The polyester-polycarbonates in particular are generally of high molecular weight and have an intrinsic viscosity, as determined in chloroform at 25° C. of 0.3 to 1.5 dl/gm, and preferably from 0.45 to 1.0 dl/gm. These polyester-polycarbonates may be branched or unbranched and generally will have a weight average molecular weight of from 10,000 to 200,000, preferably from 20,000 to 100,000 as measured by gel permeation chromatography.

Polycarbonates containing poly(carbonate-siloxane) blocks can be used. The polysiloxane blocks are polydiorganosiloxane, comprising repeating diorganosiloxane units as in formula (10)

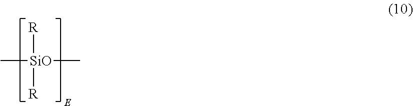

wherein each R is independently the same or different C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁ₒ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof In an embodiment, where a transparent polysiloxane-polycarbonate is desired, R is unsubstituted by halogen. Combinations of the foregoing R groups can be used in the same copolymer.

The value of E in formula (10) can vary widely depending on the type and relative amount of each component in the thermoplastic composition, the desired properties of the composition, and like considerations. Generally, E has an average value of 2 to about 1,000, specifically about 2 to about 500, more specifically about 5 to about 100. In one embodiment, E has an average value of about 10 to about 75, and in still another embodiment, E has an average value of about 40 to about 60. Where E is of a lower value, e.g., less than about 40, it can be desirable to use a relatively larger amount of the polycarbonate-polysiloxane copolymer. Conversely, where E is of a higher value, e.g., greater than about 40, a relatively lower amount of the polycarbonate-polysiloxane copolymer can be used.

A combination of a first and a second (or more) poly(carbonate-siloxane) copolymers can be used, wherein the average value of E of the first copolymer is less than the average value of E of the second copolymer.

In an embodiment, the polydiorganosiloxane blocks are of formula (11)

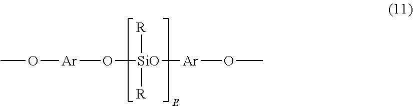

wherein E is as defined above; each R can be the same or different, and is as defined above; and Ar can be the same or different, and is a substituted or unsubstituted C₆-C₃₀ arylene group, wherein the bonds are directly connected to an aromatic moiety. Ar groups in formula (11) can be derived from a C₆-C₃₀ dihydroxyarylene compound, for example a dihydroxyarylene compound of formula (3) or (6) above. Exemplary dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations comprising at least one of the foregoing dihydroxy compounds can also be used.

In another embodiment, polydiorganosiloxane blocks are of formula (12)

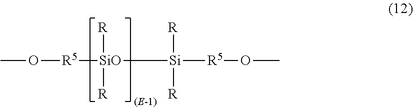

wherein R and E are as described above, and each R⁵ is independently a divalent C₁-C₃₀ hydrocarbon group, and wherein the polymerized polysiloxane unit is the reaction residue of its corresponding dihydroxy compound.

In a specific embodiment, the polydiorganosiloxane blocks are of formula (13)

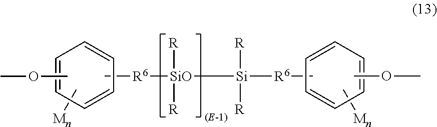

wherein R and E are as defined above. R⁶ in formula (13) is a divalent C₂-C₈ aliphatic group. Each M in formula (14) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

In an embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R² is a divalent C₁-C₃ aliphatic group, and R is methyl.

Blocks of formula (13) can be derived from the corresponding dihydroxy polydiorganosiloxane (14)

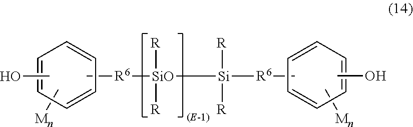

wherein R, E, M, R⁶, and n are as described above. Such dihydroxy polysiloxanes can be made by effecting a platinum-catalyzed addition between a siloxane hydride of formula (15)

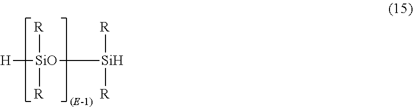

wherein R and E are as previously defined, and an aliphatically unsaturated monohydric phenol. Exemplary aliphatically unsaturated monohydric phenols include eugenol, 2-alkylphenol, 4-ally1-2-methylphenol, 4-ally1-2-phenylphenol, 4-ally1-2-bromophenol, 4-allyl-2-t-butoxyphenol, 4-pheny1-2-phenylphenol, 2-methy1-4-propylphenol, 2-ally1-4,6-dimethylphenol, 2-ally1-4-bromo-6-methylphenol, 2-ally1-6-methoxy-4-methylphenol and 2-ally1-4,6-dimethylphenol. Combinations comprising at least one of the foregoing can also be used.

The poly(carbonate-siloxane)s can comprise 50 to 99 wt. % of carbonate units and 1 to 50 wt. % siloxane units. Within this range, the poly(carbonate-siloxane)s can comprise 70 to 98 wt. %, more specifically 75 to 97 wt. % of carbonate units and 2 to 30 wt. %, more specifically 3 to 25 wt. % siloxane units.

The poly(carbonate-siloxane)s can have a weight average molecular weight of 2,000 to 100,000 Daltons, specifically 5,000 to 50,000 Daltons as measured by gel permeation chromatography using a cross-linked styrene-divinyl benzene column, at a sample concentration of 1 milligram per milliliter, and as calibrated with polycarbonate standards.

The poly(carbonate-siloxane)can have a melt volume flow rate, measured at 300° C./1.2 kg, of 1 to 50 cubic centimeters per 10 minutes (cc/10 min), specifically 2 to 30 cc/10 min. Mixtures of polyorganosiloxane-polycarbonates of different flow properties can be used to achieve the overall desired flow property.

The foregoing polycarbonates can be used alone or in combination, for example a combination of a homopolycarbonate and one or more poly(carbonate-ester)s, or a combination of two or more poly(carbonate-ester)s. Blends of different polycarbonate-esters may be used in these compositions.

The fibers are combined to produce the fibrous substrate and electrical papers disclosed herein. Generally, from about 10 to about 65 wt. % of polyimide fibers; from about 10 to about 30 wt. % of fibers selected from aromatic polyamide fibrids or polycarbonate fibers; from about 25 to about 70 wt. % aromatic polyamide fibers are present in the fibrous substrate.

In some embodiments, the resins which comprise the fibrous substrate could also be combined during a fiber extrusion process known as bi-component fiber extrusion. In such embodiments, a first polymer can be melt spun along with a second polymer to form a core/sheath fiber according to known methods. Methods for making bi-component and multicomponent fibers are well known and need not be described here in detail. For example, U.S. Pat. No. 5,227,109, which is hereby incorporated by reference, describes forming bi-component fibers in a sheath-core relationship in a spinning pack that incorporates a plurality of adjacent plates that define predetermined flow paths therein for a sheath component and a core component to direct the respective components into the sheath-core relationship. In addition, more complex multicomponent fiber morphologies may be considered within the term core sheath as used herein, such as disclosed in U.S. Pat. No. 5,458,972, which is hereby incorporated by reference, and describes a method of producing a multicomponent trilobal fiber using a trilobal capillary defining three legs, three apexes and an axial center, by directing a first molten polymer composition to the axial center and presenting a second molten polymer composition to at least one of the apexes. The fiber produced has a trilobal core defining an outer core surface and a sheath abutting at least about one-third of the outer core surface.

In various embodiments, the first polymer can be the core fiber while the second polymer is the sheath fiber, or the second polymer can be the core fiber while the first polymer is the sheath fiber. The first and second polymer can be selected from the polymers described above in the context of the useful fibers.

In an embodiment, polyetherimide would be the core and polycarbonate would be the outer layer. The embodiment would make bonding the fibers in the mat more uniform. In another embodiment, any high temperature, high strength polymer would be the core and the polyetherimide the outer layer. Examples of such core polymers include materials subject to stress-induced crystallization, semi-crystalline, or crystalline polymers, such as polyethylene terephthalates and variants of semi-crystalline polyethylenes and propylenes, such as Spectra and Dyneema, aramids (para- and meta-), poly(p-phenylene-2,6-benzobisoxazole) Zylon, polyacrylonitrile fibers, polyamides, and in some embodiments silicon nitride and carbon fibers. This embodiment would improve the uniformity of dispersion of the materials over a given area in construction of the paper. This embodiment could also allow for the production of finer fiber, which is critical for uniform dispersion in very thin products such as this.

The electrical insulation paper may be made using conventional paper making techniques, such as on cylinder or fourdrinier paper making machines. In general, fibers are chopped and refined to obtain the proper fiber size. The synthetic fibers and binder are added to a suspension solvent, such as water, to form a mixture of fibers and water.

The mixture then is screened to drain the water from the mixture to form a sheet of paper. The screen tends to orient the fibers in the direction in which the sheet is moving, which is referred to as the machine direction. Consequently, the resulting insulation paper has a greater tensile strength in the machine direction than in the perpendicular direction, which is referred to as the cross direction. The sheet of paper is fed from the screen onto rollers and through other processing equipment that removes the water in the paper.

The substrate comprising polyetherimide fibers, aromatic polyamide fibers, and aromatic polyamide fibrids may be used to form an electrical paper by consolidating the substrate alone, or in combination with additional layers. Alternatively, this substrate can be combined with additional layers of fibrous substrates to form an electrical paper. For example, the substrate comprising polyetherimide fibers, aromatic polyamide fibers, and aromatic polyamide fibrids can be arranged in a stack of layers to build thickness of the electrical paper. In one embodiment, the substrate comprising polyetherimide fibers, aromatic polyamide fibers, and aromatic polyamide fibrids is alternated with a layer of substrate of different composition. For example, the substrate comprising polyetherimide fibers, aromatic polyamide fibers, and aromatic polyamide fibrids may serve as an internal layer with a substrate of different composition arranged as outer layers. Or the substrate of different composition may serve as an internal layer with the substrate comprising polyetherimide fibers, aromatic polyamide fibers and aromatic polyamide fibrids arranged as outer layers.

In one embodiment, a fibrous substrate comprising about 20 to 65 wt. % of polyimide fibers; about 30 to 70 wt. % of aromatic polyamide fibers; about 10 to 30 wt. % aromatic polyamide fibrids; each based on the total weight of these fibers in the fiber composition; is an internal layer in a stack and having a first layer comprising about 75 to 95 wt. % polyimide fibers and about 5 to 25 wt. % aromatic polyamide fibrids disposed on the first side of the fibrous substrate; and a second layer comprising about 75 to 95 wt. % polyimide fibers and about 5 to 25 wt. % aromatic polyamide fibrids disposed on the second side of the fibrous substrate.

In another embodiment, a fibrous substrate comprising a consolidated product of a fiber composition comprising about 75 to 95 wt. % polyimide fibers and about 5 to 25 wt. % aromatic polyamide fibrids each based on the total weight of these fibers in the fiber composition, is an internal layer in a stack and having; a first layer comprising about 35 to 45 wt. % of polyimide fibers; about 35 to 45 wt. % of aromatic polyamide fibers; about 10 to 30 wt. % aromatic polyamide fibrids; disposed on the first side of the fibrous substrate; and a second layer comprising: about 35 to 45 wt. % of polyimide fibers; about 35 to 45 wt. % of aromatic polyamide fibers; about 10 to 30 wt. % aromatic polyamide fibrids disposed on the second side of the fibrous substrate.

The substrate may further comprise a layer of polymer film bound to surfaces of the fibrous substrate. Such films may include any polymer which, when used as described, produces final properties in the ranges described in the claims. Polyetherimide film is preferred. The polymer film can be from greater than 0 to 50 μm in thickness; from 4 to 40 μm; from 5 to 30 μm. Generally the polymer film is bound to a first and a second surface of the fibrous substrate. In addition, multiple layers of fibrous substrate and polymer film can be combined. For example, two layers of fibrous substrates can be alternated with three layers of polymer film. It is recommended that the combinations of fibrous substrates and polymer films be bilaterally symmetrical in order to avoid warpage. The stack of fibrous substrate(s) and polymer film(s) are generally bound by consolidation in a press or by calendering.

When combined in a stack, the relative proportion of the substrates of different compositions may be selected to produce a final consolidated product of desired properties. For paper having an overall calendered dimension of 4 mil or less the relative proportion of layers is generally from 1:1 to 2:1. In substrates of larger dimensions, the proportions can vary more widely, for example with a predominate portion of the final consolidated dimension provided by internal layers of one composition and a relatively small proportion provided by external layers of a different composition.

The fibrous substrate can be prepared in various densities known in the art, which are generally expressed in grams per square meter (GSM). Generally the density of the fibrous substrates can be from 5 to 200 GSM; 20 to 100 GSM. In a preferred embodiment the consolidated fibrous substrate has a density of 80 GSM. One of skill in the art will appreciate that individual layers of substrate of a given dimension can be combined in various ways to produce papers of greater dimensions. For example, an 80 gsm paper could be built from a 40 gsm inner layer with a 20 gsm layer on both sides.

The fibrous substrate can be prepared having various porosities. Methods of measuring porosity are known to those skilled in the art, such as ISO 5636-5:2003. In this technique, the Gurley second or Gurley unit is a unit describing the number of seconds required for 100 cubic centimeters (1 deciliter) of air to pass through 1.0 square inch of a given material at a pressure differential of 4.88 inches of water (0.188 psi), which can be expressed as square inch seconds per deciliter (s·in²/dl). In SI units, 1 s·in²/dl=6.4516 seconds per meter column of air (s/m). In one embodiment, the electrical insulation paper has a porosity of from greater than 10 to less than 120 s.in²/dl (Gurley second).

In another general aspect, a method of constructing an electrical device includes providing at least one conductor, providing an electrical insulation paper, and surrounding at least part of the conductor with the insulation paper.

In another general aspect, an insulated conductor includes an electrical conductor that is surrounded at least partly by an electrical insulation paper. In some applications, the insulated conductor may be installed in a transformer.

In some embodiments, particularly those intended to be used as electrical paper of typical dimensions, the fibrous substrate has a thickness of more than 0 to less than 8 mil. In some embodiments, particularly those built by stacking layers of fibrous substrates the thickness is from 0 to 80 mil. In other embodiments, the thickness is from 3 to 20 mil.

The fibrous substrate generally has 5 or less wt. % gain due to water saturation at 100% Relative Humidity. In other embodiments, the wt. % gain is 3% or less, and in a preferred embodiment the wt. % gain is 2% or less.

The following Examples are illustrative, and non-limiting.

### EXAMPLES

### Materials

The materials used in the Examples are shown on Table 1.

TABLE 1

| Component | Chemical Description | Source, Vendor |
|---|---|---|
| ULTEM 9011 | Polyetherimide (PEI) | SABIC Innovative Polymers |
| TWARON | Aramid Fiber | Teijin Aramid BV |
| TWARON | Aramid Fibrid | Teijin Aramid BV |

Twaron is a para-aramid polymer, specifically poly p-phenylene terephthalamide (PpPTA), commercially available from Teijin Aramid BV.

### Techniques and Procedures

Tensile Strength was determined by ASTM D828.

Percent Elongation was determined by ASTM D828.

Young's Modulus was determined by ASTM D638.

Elmendorf Tear Strength was determined by ASTM D1922

Samples were prepared according to the formulations shown on Table 2:

TABLE 2

| | | | | Basis |
|---|---|---|---|---|
| | PEI | Aramid | Aramid | Weight |
| Sample | fiber | Fiber | Fibrid | Grams/m² |
| ID | wt. % | wt. % | wt. % | (GSM) |
| A | 65 | 25 | 10 | 40 |
| B | 65 | 25 | 10 | 80 |
| C | 50 | 30 | 20 | 80 |
| D | 50 | 30 | 20 | 40 |

Paper Making Technique. A fiber slurry was formed by combining the fibers in water. The fibers were deposited on a mesh to form a layer and dewatered in a 12-inch×12-inch hand press. Consolidation of the layers was performed as follows.

Consolidation conditions. A TMP Vacuum press was prepared to accept the sample by loading a silicone bladder and a cover sheet of aluminum foil overlaying the lower stainless steel plate. The sample of mixed fibers was removed from the hand press and placed on top of the aluminum foil. Then the press platens was closed, bringing the upper stainless steel plate in contact with the sample at an initial temperature of 100° F. and a minimum system pressure of 5 tons. The temperature selector was then set for 460° F. (Samples were also consolidated at 490F.) When the temperature indicator displays 350° F., the containment doors were closed and the chamber was evacuated with the control set to full and maintain pressure below 28.9 mm Hg. When the platens reach 460° F., the temperature setting was reduced to 100° F. to start cooling, and the pressure setting was increased to 200 Tons (2778 psi) and hold. When the temperature cooled to 100° F., the vacuum was reset to ambient and the pressure to zero. The doors were opened and the sample was removed.

AC Breakdown Strength Test Procedure—ASTM D-149, using 1″ on 3″ diameter electrodes, tested in air or oil impregnated. Ramp of 100 V/sec, and trip limit of about 0.1 mA.

The samples were consolidated according to the conditions indicated on Table 3 on a continuous double belt press. Double belt presses are supplied by a number of manufacturers primarily for the production of wood sheet products and lamination of surface coverings to sheet goods. They consist of two continuous belts and traveling around drums which drive them in opposite directions, one above the other and the facing surfaces running parallel and in the same direction. These surfaces are heated, pressurized then cooled under pressure to cure the adhesive or resinous binder of the sheet or composite product.

Held Technologie GmbH makes such presses that are capable of exerting very high and even pressures on the product and is capable of heating the belts to the processing temperatures required for polyetherimide resin, followed by cooling the sheet while still under pressure.

Materials are fed into the press, for example, from a number of unwind stations, which supply the necessary materials from rolls or sheet goods. These are fed into the nip and heated and compressed as per the above description.

Consolidation Conditions for Electrical Insulation Paper: Electrical paper is very low aerial weight material generally on the order of 40 gsm to 120 gsm with higher or even much higher weight material used for some applications. Paper like materials are commercially consolidated by calendering, which uses multiple rollers stacked to provide multiple nips. The rollers are heated and turned at high speeds to process paper at very high rates in a highly competitive commercial industry. Up to now the slower, continuous belt presses have provided better results than the high speed calendering equipment to produce material meeting the requirements for electrical insulation paper at high speeds.

TABLE 3

| | | Conditions | | | | | | | |
|---|---|---|---|---|---|---|---|---|---|
| | Sample | Temperature (° C.) | | | | | Pressure | Rate | Length |
| Example | Number | Zone1 | Zone2 | Zone3 | Zone4 | Drum | (bar) | (m/min) | (m) |
| 1 | Sample A | 195 | 195 | 195 | 240 | 195 | 10 | 1 | sheets |
| 2 | Sample A | 195 | 195 | 195 | 240 | 195 | 10 | 1 | |
| 3 | Sample A | 195 | 195 | 195 | 240 | 195 | 15 | 1 | |
| 4 | Sample A | 195 | 195 | 240 | 240 | 195 | 25 | 1 | |
| 5 | Sample A | 260 | 260 | 260 | 260 | 195 | 30 | 2 | 3.68 |
| 6 | Sample A | 280 | 280 | 280 | 280 | 195 | 35 | 2 | 3.43 |
| 7 | Sample A | 240 | 240 | 240 | 240 | 195 | 35 | 2 | 3.47 |
| 8 | Sample A | 280 | 280 | 280 | 280 | 195 | 35 | 1 | 5.48 |
| 9 | Sample B | 195 | 195 | 240 | 240 | 195 | 25 | 1 | sheets |
| 10 | Sample B | 195 | 195 | 240 | 240 | 195 | 30 | 1 | |
| 11 | Sample B | 195 | 240 | 240 | 240 | 195 | 30 | 1 | |
| 12 | Sample B | 240 | 240 | 240 | 240 | 195 | 30 | 1 | |
| 13 | Sample B | 240 | 240 | 240 | 240 | 195 | 35 | 1 | |
| 14 | Sample B | 250 | 250 | 250 | 250 | 195 | 35 | 1 | |
| 15 | Sample B | 250 | 250 | 250 | 250 | 195 | 35 | 2 | |
| 16 | Sample B | 250 | 250 | 250 | 250 | 195 | 35 | 1 | 3.53 |
| 17 | Sample B | 260 | 260 | 260 | 260 | 195 | 35 | 2 | 3.53 |
| 18 | Sample B | 280 | 280 | 280 | 280 | 195 | 35 | 2 | 3.47 |
| 19 | Sample B | 240 | 240 | 240 | 240 | 195 | 35 | 2 | 3.15 |
| 20 | Sample B | 280 | 280 | 280 | 280 | 195 | 35 | 1 | 4.00 |
| 21 | Sample C | 260 | 260 | 260 | 260 | 195 | 35 | 2 | 3.77 |
| 22 | Sample C | 280 | 280 | 280 | 280 | 195 | 35 | 2 | 3.59 |
| 23 | Sample C | 240 | 240 | 240 | 240 | 195 | 35 | 2 | 3.55 |
| 24 | Sample C | 280 | 280 | 280 | 280 | 195 | 35 | 1 | 7.86 |
| 25 | Sample D | 260 | 260 | 260 | 260 | 195 | 35 | 2 | 3.43 |
| 26 | Sample D | 280 | 280 | 280 | 280 | 195 | 35 | 2 | 3.46 |
| 27 | Sample D | 240 | 240 | 240 | 240 | 195 | 35 | 2 | 3.73 |
| 28 | Sample D | 280 | 280 | 280 | 280 | 195 | 35 | 1 | 6.75 |

The physical properties of the samples were tested and the results are reported on Table 4.

TABLE 4

| | | | | | Tensile | | | | | | | |
|---|---|---|---|---|---|---|---|---|---|---|---|---|
| | | Basis | | | Strength | | Elongation | | Young's | | Elmendorf Tear | |
| | | weight | Caliper | Density | (kg/in) | | (%) | | Modulus (MPa) | | Strength (N) | |
| Example | Sample ID | (g/m2) | (mil) | g/cm3 | MD | CD | MD | CD | MD | CD | MD | CD |
| 1 | A | 40 | 2.5 | 0.63 | 6.8 | 3.1 | 3.7 | 2.2 | — | 1075 | 0.5 | 0.6 |
| 2 | A | 40 | 2.4 | 0.66 | 6.1 | 3.5 | 2.5 | 2.8 | 2067 | 982 | 0.4 | 0.9 |
| 3 | A | 40 | 2.3 | 0.68 | 5.1 | 10.8 | 2.9 | 3.0 | 1439 | 3017 | 1.0 | 0.5 |
| 4 | A | 40 | 2.2 | 0.72 | 4.3 | 8.2 | 2.8 | 2.8 | 1341 | — | 0.4 | 0.3 |
| 5 | A | 40 | 1.7 | 0.93 | 11.2 | 7.5 | 3.2 | 4.2 | 4017 | 498 | 0.2 | 0.5 |
| 6 | A | 40 | 1.8 | 0.87 | 15.9 | 6.5 | 3.6 | 3.1 | 4768 | 1898 | 0.2 | 0.4 |
| 7 | A | 40 | 2.0 | 0.79 | 11.6 | 5.7 | 3.1 | 3.1 | 3259 | 1814 | 0.2 | 0.6 |
| 8 | A | 40 | 1.8 | 0.87 | 15.3 | 8.5 | 3.5 | 3.5 | 4590 | 2826 | 0.2 | 0.4 |
| 9 | B | 80 | 3.5 | 0.90 | 17.0 | 10.6 | 4.8 | 2.7 | 2930 | — | 1.3 | 1.9 |
| 10 | B | 80 | 3.4 | 0.93 | 20.6 | 13.3 | 4.0 | 2.8 | 3451 | 2826 | 1.2 | 1.9 |
| 11 | B | 80 | 3.4 | 0.93 | 18.2 | 17.5 | 3.5 | 3.9 | 3046 | 2940 | 1.1 | 1.0 |
| 12 | B | 80 | 3.1 | 1.02 | 20.7 | 19.3 | 4.0 | 3.9 | 3539 | 3365 | 0.9 | 0.9 |
| 13 | B | 80 | 3.1 | 1.02 | 21.5 | 16.6 | 4.1 | 3.5 | 3595 | 3193 | 0.9 | 0.9 |
| 14 | B | 80 | 3.1 | 1.02 | 23.6 | 19.5 | 4.2 | 3.9 | 3868 | 3566 | 0.9 | 0.8 |
| 15 | B | 80 | 3.1 | 1.02 | 20.2 | 19.8 | 3.9 | 3.8 | 3427 | 3607 | 0.9 | 0.7 |
| 16 | B | 80 | 2.9 | 1.09 | 21.9 | 18.4 | 4.1 | 3.7 | 4083 | 3590 | 0.7 | 0.8 |
| 17 | B | 80 | 2.9 | 1.09 | 23.8 | 21.0 | 4.3 | 3.8 | 4255 | 3841 | 0.7 | 0.8 |
| 18 | B | 80 | 2.8 | 1.12 | 24.6 | 23.0 | 4.2 | 4.2 | 4571 | 4245 | 0.7 | 0.9 |
| 19 | B | 80 | 3.1 | 1.02 | 20.9 | 19.5 | 4.1 | 3.8 | 3725 | 3503 | 1.1 | 1.1 |
| 20 | B | 80 | 2.9 | 1.09 | 24.9 | 22.3 | 4.3 | 4.1 | 4436 | 4047 | 1.0 | 1.1 |
| 21 | C | 80 | 3.8 | 0.83 | 22.0 | 18.3 | 3.7 | 3.2 | 3570 | — | 1.4 | 1.3 |
| 22 | C | 80 | 3.5 | 0.90 | 19.9 | 19.2 | 3.5 | 3.5 | 3624 | 3572 | 1.1 | 2.4 |
| 23 | C | 80 | 3.8 | 0.83 | 14.5 | 11.3 | 3.0 | 2.1 | — | — | 2.1 | 2.3 |
| 24 | C | 80 | 3.4 | 0.93 | 20.9 | 25.8 | 4.8 | 4.0 | 2983 | 4257 | 1.0 | 1.0 |
| 25 | D | 40 | 2.1 | 0.75 | 8.0 | 7.4 | 2.9 | 2.4 | — | — | 0.5 | 0.7 |
| 26 | D | 40 | 2.0 | 0.79 | 9.3 | 9.8 | 3.2 | 3.0 | — | — | 0.5 | 0.4 |
| 27 | D | 40 | 2.3 | 0.68 | 5.9 | 5.7 | 2.1 | 2.1 | — | — | 0.7 | 0.8 |
| 28 | D | 40 | 2.0 | 0.79 | 10.9 | 10.3 | 3.2 | 2.9 | — | — | 0.5 | 0.4 |

DISCUSSION: The above data compares favorably to the calendered paper data, by providing higher strength and lower porosity and a lower differential between machine and cross machine direction.

All cited patents, patent applications, and other references are incorporated herein by reference in their entirety.

Although the present invention has been described in detail with reference to certain preferred versions thereof, other variations are possible. Therefore, the spirit and scope of the appended claims should not be limited to the description of the versions contained therein.

1. A fibrous substrate comprising a consolidated product of a fiber composition consisting of, based on the total weight of fibers in the fiber composition:
from about 50 to about 65 wt. % of polyimide fibers;
from about 10 to about 20 wt. % of fibers selected from aromatic polyamide fibrids or polycarbonate fibers;
from about 25 to about 30 wt. % aromatic polyamide fibers;
wherein the consolidated product has a thickness of from more than 0 to less than 8 mils.

2. An electrical paper comprising the fibrous substrate of claim 1.

3. The electrical paper of claim 2, wherein the polyimide fibers are selected from polyetherimide fibers, polyetherimidesulfone fibers, polyetheramideimide fibers, and combinations thereof

4. The electrical paper of claim 2, wherein the polyimide fibers are polyetherimides having a polydispersity index ranging from 2.2 to 2.5.

5. The electrical paper of claim 2, wherein at least one of the aromatic polyamide fibrid and aromatic polyamide fiber is an aromatic para-polyamide.

6. The electrical paper of claim 5, wherein the aromatic para-polyamide is selected from poly(p-phenylene terephthalamide), poly(p-phenylene terephthalamide-co-3′4′-oxydiphenylene terephthalamide), and combinations thereof

7. The electrical paper of claim 2, wherein the thickness of the substrate is from about 1.0 to 5 mils.

8. The electrical paper of claim 2, wherein the thickness of the substrate is from 2 to 4 mi1s.

9. The electrical paper of claim 2, further comprising a thermosetting or thermoplastic polymer impregnated in the fibrous substrate.

10. An article comprising the electrical paper of claim 2.

11. The article of claim 10, wherein the article is a phase separator, primary insulation in a motor, generator, or transformer, secondary insulation in a motor, generator, or transformer.

12. An electrical paper comprising
a fibrous substrate having a first side and a second side opposite the first side, and comprising a consolidated product of a fiber composition comprising:
about 20 to 65 wt. % of polyimide fibers;
about 30 to 70 wt. % of aromatic polyamide fibers;
about 10 to 30 wt. % aromatic polyamide fibrids;
each based on the total weight of these fibers in the fiber composition; and having
a first layer comprising about 75 to 95 wt. % polyimide fibers and about 5 to 25 wt. % aromatic polyamide fibrids disposed on the first side of the fibrous substrate; and
a second layer comprising about 75 to 95 wt. % polyimide fibers and about 5 to 25 wt. % aromatic polyamide fibrids disposed on the second side of the fibrous substrate, wherein the electrical paper has a thickness of from more than 0 to less than 8 mil.

13. The electrical paper of claim 12, wherein the fibrous substrate comprises about 40 wt. % polyimide fibers, about 40 wt. % aromatic polyamide fibers and about 20 wt. % aromatic polyamide fibrids and the first and second layers comprise about 90 wt. % polyimide fibers and about 10 wt. % aromatic polyamide fibrids.

14. The electrical paper of claim 12, wherein the polyimide fibers are selected from polyetherimide fibers, polyetherimidesulfone fibers, polyetheramideimide, and combinations thereof

15. The electrical paper of claim 12, wherein the polyimide fibers are polyetherimides having a polydispersity index ranging from 2.2 to 2.5.

16. The electrical paper of claim 12, wherein the aromatic polyamide is an aromatic para-polyamide.

17. The electrical paper of claim 12, wherein the thickness of the substrate is from about 2.5 mils to 40 mils.

18. The electrical paper of claim 12, further comprising a thermosetting or thermoplastic polymer impregnated in the fibrous substrate.

19. An article comprising the electrical paper of claim 12.

20. The article of claim 12, wherein the article is a phase separator, primary insulation in a motor, generator, or transformer, secondary insulation in a motor, generator, or transformer.
